(19) United States
(12) Patent Application Publication
(10) Pub. No.: US 2015/0258702 A1
(43) Pub. Date: Sep. 17, 2015

(54) AUXILIARY PLATE FOR SHEET-MEMBER PROCESSING DEVICE AND SHEET-MEMBER PROCESSING DEVICE USING THE SAME

(71) Applicant: HARADA KIGATA KOGYO CO., LTD., Aichi (JP)

(72) Inventors: Naoki HARADA, Aichi (JP); Hidekazu HARADA, Aichi (JP)

(21) Appl. No.: 14/656,308

(22) Filed: Mar. 12, 2015

(30) Foreign Application Priority Data
Mar. 12, 2014 (JP) 2014-049510

(51) Int. Cl. B26F 1/44

(52) U.S. Cl. CPC B26F 1/44

(57) ABSTRACT

To provide an auxiliary plate and a processing device that can suppress the occurrence of damage to a surface of a sheet member such as a corrugated cardboard with a large thickness. An auxiliary plate includes a plate body with a flat-plate shape, and a cutting-blade contact portion provided on a surface of this plate body at a position opposed to a cutting blades arranged in the stamping die, so as to protrude from the surface, while including a contact surfaces with a width dimension greater than a thickness of the cutting blade. The contact surface of the cutting-blade contact portion is chamfered at both edges in its width direction.

### CROSS-REFERENCE TO RELATED APPLICATION

The present application claims priority from Japanese patent application No. 2014-049510 filed on Mar. 12, 2014, the entire contents of which are hereby incorporated by reference.

### TECHNICAL FIELD

The present invention relates to a processing device to be used for stamping a paper sheet member such as a corrugated cardboard, and relates to an auxiliary plate that receives contact of the distal end of a cutting blade.

### DESCRIPTION OF RELATED ART

There have been employed a stamping method and a feed roller method for a device that processes a paper sheet member such as a corrugated cardboard. In the feed roller method, a cutting roller with a cutting blade provided around the entire periphery, and a receiver roller that receives contact of this cutting blade rotate in conjunction with conveyance of a sheet member to cut the sheet member by means of their rotation. Therefore, the feed roller method is suitable for cutting a sheet member in a continuous straight line. However, the stamping method has been employed for cutting a sheet member in a complicated shape, for example, a curved shape, or for cutting a portion away from a sheet member.

In the case of processing a sheet member using the stamping method, a cutting blade that cuts a sheet member in a desired shape is arranged in a stamping die, and this stamping die is fixed to a punching die portion. A sheet member that is a workpiece member is placed on the surface of a cutting plate portion, and then the cutting blade and the cutting plate portion are brought closer to each other to cut the sheet member between the blade edge of the cutting blade and the surface of the cutting plate portion.

In a sheet-member processing device using the stamping method as described above, a portion of a material sheet member is stamped into a product. Therefore, after the cutting processing, there are a product portion and an excess portion, and by separating the excess portion from the product portion, a product with a desired shape can be obtained. However, when a sheet member with a relatively large thickness such as a corrugated cardboard is subjected to cutting processing, the cutting blade enters into the sheet member, and therefore compresses at least the surface of the corrugated cardboard. This leads to a phenomenon in which the corrugated cardboard is collapsed (a so-called wall collapse) during the cutting processing. A plurality of long cutting blades simultaneously enter into a sheet member, and therefore compress the sheet member in a horizontal direction by an amount corresponding to the thickness of the entering cutting blades. Accordingly, not only during the cutting, but also after completion of the cutting, the edges of the cut portions press the side of the cutting blades. This brings them into sliding contact. Therefore, a phenomenon occurs where the cut sheet member is not easily separated from the cutting blades. Thus, because the sheet member having been cut moves along with the cutting blades, it is necessary to separate the sheet member from the cutting blades. In order to eliminate this, an elastic member is generally arranged on one or both of the sides of a cutting blade at an appropriate point, and after cutting a sheet member, an elastic force of the elastic member causes the sheet member to come off the cutting blades.

As known in public, in the structure of a corrugated cardboard, a corrugated reinforcing web is provided in the middle of the surface sheet and the back sheet, and this reinforcing web is interposed between the surface sheet and the back sheet to ensure a desired strength. There are several types of corrugated cardboard such as a corrugated cardboard with a single layer of reinforcing web (single-wall), and multi-wall corrugated cardboards with double layers (double-wall), triple layers (triple-wall), or more than three layers of reinforcing web. As the number of walls in a corrugated cardboard increases, the thickness of the corrugated cardboard increases.

In the case of a sheet member with a relatively small thickness, such as a single-wall corrugated cardboard, an elastic member, provided near a cutting blade in a stamping die, applies an appropriate elastic force to the corrugated cardboard to enable it to come off the cutting blade without damaging the surface sheet or the back sheet of the corrugated cardboard. However, in the case of a sheet member with a relatively large thickness such as a multi-wall-structure corrugated cardboard, there is a limit to the application of an elastic force of the elastic member. Therefore, in the case of applying a considerable elastic force by means of such as selecting the size or material of an elastic member, this elastic member considerably presses the contact side, and accordingly can damage the surface sheet in contact with the elastic member or the back sheet. In contrast, in the case of applying a slight elastic force in order to protect a sheet member, this leads to a phenomenon in which the sheet member does not sufficiently come off the cutting blade.

In order to eliminate the inconvenience described above, a configuration has been conventionally proposed to provide a hole near a cutting blade of a stamping die, which is larger than an elastic member to be located, and to locate the elastic member in this hole (see Patent Document 1). With this configuration, at the time of cutting, the elastic member comes into contact with the surface of a corrugated cardboard, and elastically deforms, while applying an elastic force to the surface. At the time of the elastic deformation, the elastic member deforms also in a direction to enlarge its cross section depending on the size of the hole. Therefore, the elastic force generated by the elastic member is distributed to the hole, and accordingly not all the elastic force is applied to the surface of the corrugated cardboard. When the elastic deformation is maximized, the elastic force to be applied to the corrugated cardboard is reduced. When the corrugated cardboard comes off the cutting blade, the elastic member gradually recovers from elastic deformation, and applies an appropriate elastic force to the corrugated cardboard.

There has been a configuration, not regarding the technique for a cutting blade, but regarding processing using a ruled-line pressing blade that forms a thinner portion to be used for bending a corrugated cardboard (hereinafter, “ruled line”), in which a protruding portion is provided on the surface of a cutting plate portion at a position opposed to the ruled-line pressing blade in order to prevent the corrugated cardboard from a wall collapse (see Patent Document 2). A corrugated cardboard, compressed by a ruled-line pressing blade in one direction, deforms considerably on the surface in contact with this ruled-line pressing blade, and the surface sheet on the contact side or the back sheet is pulled and thus broken sometimes. Therefore, the above configuration is intended to compress a corrugated cardboard from both sides in order to reduce the tensile amount of the surfaces on both sides.

### RELATED-ART DOCUMENTS

### Patent Documents

[Patent Document 1] Japanese Patent Application Publication No. 2001-88095 (JP 2001-88095 A)
[Patent Document 2] Japanese Patent Application Publication No. 10-249958 (JP 10-249958 A)

### SUMMARY OF THE INVENTION

The aforementioned invention described in Patent Document 1 controls the deforming shape of the elastic member when it is compressed. Therefore, controlling the deforming state in such a manner as to apply a desired elastic force according to the thickness of a corrugated cardboard is not easy. In the case of cutting a corrugated cardboard with a large thickness, there is a complicated relationship of mechanics applied to the corrugated cardboard around a cutting blade. At the initial stage when the cutting blade enters into the corrugated cardboard, the cutting blade deforms the surface sheet, and applies a tensile load thereto. Thereafter, upon the start of cutting, the cutting blade applies a compressing load by its entry into the corrugated cardboard. Under the conditions where both the tensile load and the compressing load are applied to the surface sheet, an elastic force is applied on the surface of the corrugated cardboard. Therefore, while the surface of the corrugated cardboard near the cut portion is displaced slightly, an elastic force of the elastic member is applied so as to suppress this displacement. Accordingly, damage to the surface of the corrugated cardboard cannot be sufficiently prevented.

Meanwhile, the aforementioned invention described in Patent Document 2 is designed to form a ruled line partially on a corrugated cardboard by means of compression using a ruled-line pressing blade. An object of this invention is to set the bending position for bending a portion of the corrugated cardboard, and to stabilize this bending. A cutting blade is configured to cut a corrugated cardboard by coming into contact with the surface of a cutting plate portion. In comparison to this, the position of the distal end of the ruled-line pressing blade has an appropriate clearance from the cutting plate portion. Therefore, it is necessary to take into account a relative positional relationship with the distal end of the cutting blade, and the protruding length. This results in a problem that it is difficult to adjust the relative positional relationship and the protruding length, and also an existing stamping die cannot be used directly.

The present invention has been made in view of the foregoing problems, and an object of the present invention is to provide an auxiliary plate and a processing device that can suppress the occurrence of damage to a surface of a sheet member such as a corrugated cardboard with a large thickness.

An auxiliary plate for a sheet-member processing device according to the present invention is an auxiliary plate for a sheet-member processing device that includes a punching die portion that holds a stamping die with a cutting blade arranged in a predetermined shape, and a cutting plate portion that is arranged opposed to this punching die portion to place thereon a sheet member that is a workpiece material, the sheet-member processing device bringing the punching die portion and the cutting plate portion closer to each other to cut a sheet member, in which the auxiliary plate is mounted on a surface of the cutting plate portion, the auxiliary plate including a plate body with a flat-plate shape, and a cutting-blade contact portion that is provided on a surface of this plate body at a position opposed to a cutting blade arranged in the stamping die, so as to protrude from the surface, while including a contact surface with a width dimension greater than a thickness of the cutting blade, wherein the contact surface of the cutting-blade contact portion is chamfered at both edges in its width direction.

According to the above configuration, on the auxiliary plate mounted on the surface of the cutting plate portion, the cutting-blade contact portion is provided at a position opposed to the cutting blade of the stamping die. Because this cutting-blade contact portion protrudes from the surface of the plate body of the auxiliary plate, a sheet member that is a workpiece material is cut at a position on the contact surface (the top surface) of the cutting-blade contact portion. That is, when the auxiliary plate is located such that the plate body is stacked almost on the entire surface of the cutting plate portion, the cutting position is set above the plate surface. With this configuration, the sheet member, placed on the auxiliary plate to be cut, stops at the height of the contact surface of the cutting-blade contact portion in a stable manner. There is the cutting-blade contact portion immediately below a portion of the sheet member to be cut. The other portion is positioned between adjacent cutting-blade contact portions with an appropriate clearance from the surface of the plate body. That is, a space region from the plate surface to the contact surface of the cutting-blade contact portion is formed below an uncut portion of the sheet member.

Therefore, at the time of cutting processing, the sheet member is in a state where only the cut portion is compressed in its thickness direction, and the other portion bulges. This bulging portion can be brought into a state of extending in the space region. That is, a clearance region for the bulging portion is formed. There is the clearance region for the bulging portion as describe above, and therefore in the case of cutting a corrugated cardboard with a large thickness, when the blade edge of the cutting blade presses the corrugated cardboard, the cut portion is thinned by the pressure, while the other portion can freely bulge on both the surface side and the back side. As compared to the case where the other portion bulges only on one side, the extent of deformation is reduced, and consequently, the occurrence of a break on the surface, a wall collapse, and other damage can be suppressed.

The contact surface of the cutting-blade contact portion is chamfered at both edges in its width direction. This smoothes deformation of the surface of a sheet member in proximity to the boundary between the cut portion compressed by the cutting blade and by the cutting-blade contact portion, and the portion bulging from the compressed position toward the clearance region, and can suppress a trace or a break that can occur due to pressing the surface of the sheet member against the cutting-blade contact portion. The contact surface is preferably chamfered into an arc shape in cross section rather than a flat contact surface, and is more preferably chamfered into an arc shape with a large diameter.

In the above invention, the auxiliary plate may further include an elastic member that is arranged near a portion of the cutting-blade contact portion along the cutting-blade contact portion, and that is provided to protrude from the surface of the plate body.

As in the above configuration, the elastic member is provided near the cutting-blade contact portion. Therefore, the back side of the sheet member can be pressed against the contact surface of the cutting-blade contact portion by the cutting blade with a reduced force. This can suppress damage to the back side of the sheet member caused by the contact surface of the cutting-blade contact portion. Further, the elastic member can apply a repulsion force to the sheet member pressed toward the surface of the plate body. For example, in the case of cutting out a portion of a sheet member (cutting-out processing), the cut-out portion can be prevented from dropping to a space region formed between adjacent cutting-blade contact portions. Further, aside from the cutting-out processing, a situation, where the edge of the cut portion comes into contact with the side of the cutting-blade contact portion, can also be avoided.

In the present invention of the above configuration, the elastic member may have a protruding length greater than that of the cutting-blade contact portion.

According to the above configuration, a repulsion force generated by the elastic member can be effectively used. That is, the elastic member is provided to protrude more than the cutting-blade contact portion, and therefore when the sheet member is pressed by the cutting blade, the elastic member elastically deforms even before the cutting blade reaches the cutting-blade contact portion. Accordingly, the back side of the sheet member is pressed against the cutting-blade contact portion with a reduced force. Because after the cutting processing, the shape of the elastic member recovers, it is possible to lift the sheet member upward relative to the cutting-blade contact portion, and therefore the cutting-blade contact portion and the sheet member can be prevented from remaining in a contact state.

In the auxiliary plate according to the present invention, the cutting-blade contact portion in the configuration of the above invention may be configured to be split into a plurality of sections, and a contact surface of the cutting-blade contact portion may be partially discontinued.

With the above configuration, even in the case where the cutting blade is arranged continuously, there can be provided a portion of the cutting blade not in contact with the cutting-blade contact portion. That is, a sheet member can be processed, while a completely-cut section and a partially-cut section are distinguished from each other. This is intended not to completely separate a cut-out portion from the other portion, for example, in the case of cutting-out processing. That is, in the cutting-out processing, among the cut-out portion and the other portion, one of them becomes the product, while the other becomes the excess portion. Because in conventional processing, portions to be cut are all completely cut, a cut-out portion and the other portion completely separate from each other. Therefore, it is troublesome to only select and remove a product portion. In contrast to this, the cut-out portion is not entirely cut from the other portion, but in a partially-connected state with the other portion. Therefore, immediately after the processing, the cut-out portion and the other portion do not separate from each other, and thus the product portion and the excess portion can integrally be removed simultaneously. Because there is a slight clearance between the discontinued contact surfaces of the cutting-blade contact portion, an incompletely-cut region can be limited to a slight range. This makes it possible to manually separate this region later. Therefore, immediately after the processing, the product portion and the excess portion are in an unseparated state, and at the subsequent step, only the product portion can be easily separated from the excess portion.

Further, the cutting-blade contact portion in the configuration of each of the above inventions may have a protruding length less than a thickness of the workpiece material.

With the above configuration, a large clearance is not formed between the bottom surface of a sheet member and the surface of the plate body at the time of cutting processing. As described above, by forming a relatively small clearance between the bottom surface of the sheet member and the surface of the plate body, a clearance region can be formed for the bottom surface of the sheet member to bulge at the time of cutting processing, and the sheet member is allowed to bulge also toward the cutting blade (toward the stamping die). Particularly, in the case where in the bulging state, the bottom surface of the sheet member comes into contact with the surface of the plate body, a pressing force of a ruled-line pressing blade can be received by the surface of the plate body. The ruled-line pressing blade is located in the stamping die in order to form a bending position on one side. In the case of forming a ruled line simultaneously with cutting, a counterpart that receives a pressing force of the ruled-line pressing blade is needed, and the plate body can function as the counterpart.

The plate body in the configuration of each of the above inventions may include a convex portion that protrudes from the surface of the plate body at a position opposed to a ruled-line pressing blade located in the stamping die.

According to the above configuration, the convex portion can receive a pressing force of the ruled-line pressing blade that forms a ruled line aside from cutting processing using the cutting blade. Also in the case of forming a ruled line, a moderately large degree of pressing force is applied to a ruled-line forming portion. Therefore, the back side of the sheet member bulges sometimes, and can use the clearance region for the bulge. By providing the convex portion as described above, it is unnecessary to precisely adjust the protruding length of the cutting-blade contact portion. That is, because the cutting blade and the ruled-line pressing blade are the sections that press a sheet member, no additional pressing force is applied to the surface of the plate body, and the position of the surface of the plate body can be set to any position. Therefore, the protruding length of the cutting-blade contact portion only needs to be great enough for a space portion, formed on the surface of the plate body, to function as a clearance region for a bulging portion of the sheet member.

The convex portion of the plate body in the above configuration may protrude to a height equal to that of a surface of the cutting-blade contact portion.

With the above configuration, when an existing stamping die is still used, a desired clearance can be formed between the ruled-line pressing blade and the convex portion in a state where the blade edge of the cutting blade comes into contact with the surface of the cutting-blade contact portion. That is, in a conventional stamping die that has already been manufactured and used, a cutting blade and a ruled-line pressing blade are located such that, in a state where the blade edge of the cutting blade comes into contact with the surface of a flat-shaped cutting plate portion, the distal end of the ruled-line pressing blade has a predetermined clearance formed from the surface of the cutting plate portion. Therefore, the cutting-blade contact portion that receives contact of the blade edge of the cutting blade is provided, which changes a relative positional relationship between the blade edge of the cutting blade and the distal end of the ruled-line pressing blade. Accordingly, the convex portion and the cutting-blade contact portion are made equal in height, and thus the change in the relative positional relationship can be eliminated.

The convex portion of the plate body in the configuration may be provided with its distal end protruding more than the cutting-blade contact portion.

With the above configuration, it is also possible for the ruled-line pressing blade, provided in the stamping die, and the distal end of the convex portion, provided on the plate body, to form a ruled line on both surfaces of a sheet member. That is, a sheet member placed on the cutting plate portion is pressed by the cutting blade as the punching die portion becomes closer to the sheet member, and stops on the contact surface of the cutting-blade contact portion. However, because the distal end of the convex portion is in a state of protruding more than the contact surface of the cutting-blade contact portion, the sheet member can be pressed on both sides between the distal end of the convex portion and the ruled-line pressing blade of the stamping die. Therefore, by compressing the sheet member from both surfaces within the range where a ruled line is to be formed, a ruled line can be formed on both of the surfaces. With the above configuration, in order to form an appropriate clearance between the distal end of the ruled-line pressing blade of the stamping die, and the distal end of the convex portion on the plate body, the protruding length of the ruled-line pressing blade and the protruding length of the convex portion are adjusted. When the distal end of the convex portion has an identical shape to the distal end of the ruled-line pressing blade, a ruled line can be formed on the back side of the sheet member identically to the surface side of the sheet member. A ruled line is formed on both surfaces of the sheet member using the above plate, and therefore in bending processing on the sheet member, the sheet member can be bent with ease in both directions toward the surface side and the back side.

A sheet-member processing device according to the present invention is a sheet-member processing device using the auxiliary plate according to any one of the above inventions, the sheet-member processing device including a punching die portion that holds a stamping die with a cutting blade arranged in a predetermined shape, and a cutting plate portion that is arranged opposed to this punching die portion to place thereon a sheet member that is a workpiece material, wherein the punching die portion includes a positioning portion for locating the stamping die, and the cutting plate portion includes a positioning portion for locating a plate body of the auxiliary plate, and the stamping die and the auxiliary plate are located according to the positioning portions to arrange the cutting blade and the cutting-blade contact portion at a predetermined position, and also when the punching die portion and the cutting plate portion are brought closer to each other to stamp a sheet member, where a state, in which a distal end of a cutting blade comes into contact with a cutting-blade contact portion of a counter plate, is set as an approach limit between a punching die portion and a material contact portion, the sheet member is pressed with a predetermined pressure at the approach limit.

According to the above configuration, the cutting blade located on the stamping die, and the cutting-blade contact portion located on the auxiliary plate can pair up with each other to cut a sheet member. That is, because the cutting blade can cut a sheet member by coming into contact with the contact surface of the cutting-blade contact portion, the cutting blade and the cutting-blade contact portion need to be arranged at a position opposed to each other. The stamping die and the auxiliary plate, each of which is configured as an individual member, are located at a predetermined position according to their respective positioning portions. Therefore, the cutting blade and the cutting-blade contact portion can be brought into contact with each other reliably at a position opposed to each other.

A state, where the blade edge of the cutting blade comes into contact with the contact surface of the cutting-blade contact portion, is set as an approach limit. This can prevent the cutting blade or the cutting-blade contact portion from being damaged. A general sheet-member processing device uses a press machine. Therefore, when the press machine operates beyond the approach limit, a pressure more than necessary is applied to a sheet member. Accordingly, by setting the back-and-forth movable range of a movable portion of the press machine to the above approach limit, only a desired pressure can be applied to a sheet member. Pressing a sheet member with a predetermined pressure at the approach limit means that a pressing force required for cutting the sheet member is applied to the sheet member. A thin-film sheet member can also be cut by being pressed with a predetermined pressure from the approach limit. Particularly, in the case of cutting a material of thin-film sheets on the top and bottom sides, such as a corrugated cardboard, it is necessary to press the material with a desired pressure.

In the sheet-member processing device according to the present invention, in the stamping die in the configuration of the above invention, within a range of all or a portion of one side or both sides of a cutting blade, an elastic member that protrudes more than a blade edge of the cutting blade may be preferably arranged.

According to the above configuration, a sheet member having been cut can be prevented from remaining in a state of entering in between adjacent cutting blades. This type of elastic member has been employed also in a conventional processing device. However, in the above configuration, the elastic member can be used without special improvement even for a sheet member with a relatively large thickness. Therefore, an existing stamping die can still be used. Further, according to the processing device of the above configuration, the auxiliary plate described previously is located on the cutting plate portion. Therefore, a sheet member not only bulges toward the cutting blade (toward the stamping die), but can also bulge on the back side toward the auxiliary plate. This can reduce the bulging amount of the sheet member toward the cutting blade, and therefore it is possible to decrease an elastic force of the elastic member located near the cutting blade. Accordingly, in the case where an existing stamping die is not used, but a new stamping die is manufactured, an elastic force can be decreased as compared to a conventional elastic member (that is, the elastic member can be downsized). As described above, by reducing the application of an elastic force, a repulsion force to the surface of the sheet member is reduced. This can avoid the likelihood of damage to a sheet member at the time of processing.

In the auxiliary plate according to the present invention, because the cutting-blade contact portion is provided on the surface of the auxiliary plate mounted on the cutting plate portion, and thus receives contact of the cutting blade, it is possible to cut a sheet member. In a range where no cutting-blade contact portion is provided, a space region is formed between the plate body and the sheet member by the protruding cutting-blade contact portions. This makes it possible for the sheet member to bulge at the time of cutting processing. Therefore, a tensile load to be applied to the surface of the sheet member can be reduced to reduce damage such as a break on the surface. These effects are significant particularly for a sheet member with a large thickness because it deforms to a large extent due to a pressing force of the cutting blade. As described above, the sheet member is allowed to bulge (deform) on both surfaces, and therefore the fitted amount of the sheet member, having been cut by the cutting blade, into the stamping die can be reduced. This can reduce the application of an elastic force (a repulsion force) of the elastic member provided in the stamping die. Consequently, the surface of the sheet member only needs to be moderately pressed. This helps further reduce damage. An elastic member is also located on the auxiliary-plate side. This can reduce the occurrence of a damage caused by deformation of a sheet member on this auxiliary-plate side.

Meanwhile, in the sheet-member processing device according to the present invention, there is the auxiliary plate as described above. This can reduce the occurrence of damage to the surface of a sheet member. Further, the cutting blade of the stamping die pairs up with the cutting-blade contact portion of the auxiliary plate to perform cutting processing. The stamping die can be located at a predetermined position by the positioning portion of the punching die portion, and also the auxiliary plate can be located at a predetermined position by the positioning portion of the cutting plate portion. Therefore, the position, where the cutting blade and the cutting-blade contact portion are to be located, is based on their positioning portions, and accordingly their relative positional relationship can be maintained in the same state at the time of using the sheet-member processing device. The auxiliary plate and the cutting-blade contact portion are mounted on the cutting plate portion. Therefore, it is possible to also use an existing stamping die by adjusting an approach limit between the punching die portion and the cutting plate portion.

### BRIEF DESCRIPTION OF THE DRAWINGS

FIG. 1 is an explanatory diagram that schematically shows an auxiliary plate according to a first embodiment, and a sheet-member processing device using this auxiliary plate;

FIG. 2A is an explanatory diagram that shows the auxiliary plate in detail, and FIG. 2B is an explanatory diagram that illustrates the shape of a corrugated cardboard as a product;

FIGS. 3A to 3D are explanatory diagrams that show a cutting state on the auxiliary plate according to the first embodiment;

FIGS. 4A to 4C are explanatory diagrams that show a cutting state on the auxiliary plate according to the first embodiment;

FIGS. 5A to 5C are explanatory diagrams that show a cutting state on the auxiliary plate according to the first embodiment;

FIGS. 6A and 6B are explanatory diagrams of an auxiliary plate according to a second embodiment, and FIG. 6C is an explanatory diagram that shows a ruled-line pressing state in a conventional processing device;

FIG. 7 is an explanatory diagram that shows a sheet-member processing device according to an embodiment of the present invention; and

FIG. 8 is an explanatory diagram that shows the sheet-member processing device according to the embodiment of the present invention.

### DETAILED DESCRIPTION OF EMBODIMENTS

An embodiment of the present invention is described below with reference to the drawings. The present invention relates to a stamping device for a paper sheet member such as a corrugated cardboard, and therefore a corrugated-cardboard stamping device is first described schematically.

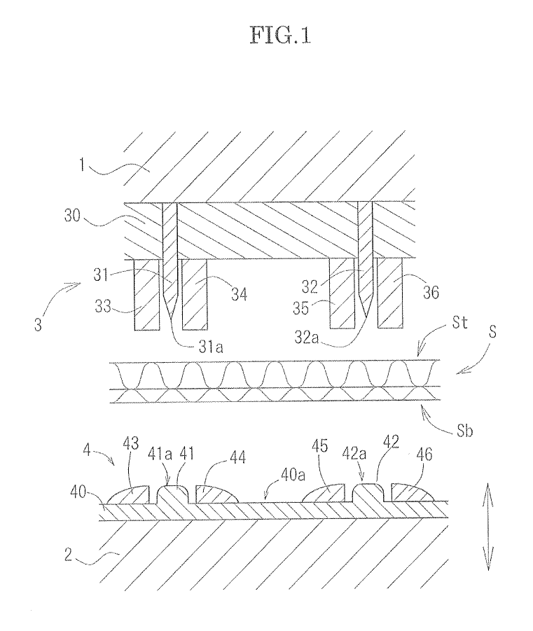

FIG. 1 schematically shows a processing device using the present invention. As shown in FIG. 1, in the processing device, an upper punching die portion 1 and a lower cutting plate portion 2 are arranged opposed to each other. The punching die portion 1 holds a stamping die 3. In the stamping die 3, at a cutting position, cutting blades 31 and 32 are provided perpendicularly with their respective blade edges 31a and 32a facing toward the cutting plate portion 2. The cutting blades 31 and 32 press a sheet member (a corrugated cardboard) S, located between the stamping die 3 and the cutting plate portion 2, to cut the sheet member S. In a general processing device, the cutting plate portion 2 is capable of moving up and down. When this cutting plate portion 2 moves up, the sheet member S receives contact of the cutting blade 31 of the stamping die 3, and then can be cut. After cutting the sheet member S, the cutting plate portion 2 moves down in order that the sheet member S having been cut can be removed.

The stamping die 3 is generally referred to as “Thompson blade die.” In a base portion of wood such as plywood (a so-called die board) 30, groove portions that accommodate the cutting blades 31 and 32 therein are provided by laser or other processing. Along these groove portions, the cutting blades (these cutting blades are referred to as “Thompson blade”) 31 and 32 are located. The groove portions, and the cutting blades 31 and 32 are provided continuously in a vertical direction to the plane of the drawing sheet. The blade edges 31a and 32a protrude sufficiently from the base portion 30 to be capable of cutting the sheet member S with a large thickness. In a general stamping die, the die board 30 has a thickness of 16 mm, the cutting blades 31 and 32 have a length of 23.6 mm, and the protruding length of the cutting blades 31 and 32 from the die board 30 is adjusted to 7.6 mm. The cutting blades 31 and 32 with a thickness of 0.9 mm are generally used. Near the cutting blades 31 and 32, elastic members 33, 34, 35, and 36 are located in a state of protruding from the base portion 30 so as to apply an appropriate elastic force to the top surface of the sheet member S to be cut, in order to cause sheet member S having been cut to come off the stamping die 3.

The present invention relates to an auxiliary plate 4 mounted on the above cutting plate portion 2. FIG. 1 shows a first embodiment of the present invention. As shown in FIG. 1, the auxiliary plate 4 according to the present embodiment is configured to include a plate body 40, and cutting-blade contact portions 41 and 42 that are provided to protrude from a surface 40a of the plate body 40. The plate body 40 is formed from a smooth plate member so as to be stacked on the surface of the cutting plate portion 2, and has a sufficient area. On the surface 40a, the cutting-blade contact portions 41 and 42 are provided respectively at a position opposed to the cutting blades 31 and 32 of the stamping die 3. The plate body 40 has a thickness of 1 mm. Stainless steel (SUS) is used for the plate body 40 in order to maintain the strength.

At the distal-end portion of the cutting-blade contact portions 41 and 42, flat contact surfaces 41a and 42a are formed, respectively. These contact surfaces 41a and 42a are formed into a flat shape. This makes it possible for the blade edges 31a and 32a of the cutting blades 31 and 32 to come into contact with the contact surfaces 41a and 42a. That is, the contact surfaces 41a and 42a are formed into a flat shape, and therefore can obtain an appropriate width dimension to allow a location error within the range of this width dimension. Further, the contact surfaces 41a and 42a are formed into a flat shape, and thus have an appropriate area. It is also possible to come into contact with a back surface Sb of the sheet member S by using this area. The protruding length of the cutting-blade contact portions 41 and 42, and the width dimension of the contact surfaces 41a and 42a are adjusted appropriately according to the size, material, and other factors of the sheet member S to be processed. The contact surfaces 41a and 42a are chamfered into an arc shape on both sides (at both edges in their width direction). This facilitates deformation of the back surface Sb of the sheet member S at the time of cutting processing, as described later.

Also near the cutting-blade contact portions 41 and 42, elastic members 43, 44, 45, and 46 are provided. These elastic members 43 to 46 are also provided to apply an elastic force to the sheet member S. While the elastic members 43 to 46 may have a rectangular shape in cross section, the top-surface portion may be formed into a slanted shape, or may be formed into an arc shape as shown in FIG. 1. The top-surface portion has an arc shape in cross section to facilitate deformation of the back surface Sb of the sheet member S at the time of cutting processing, similarly to the above chamfered portion on both sides of the contact surfaces 41a and 42a.

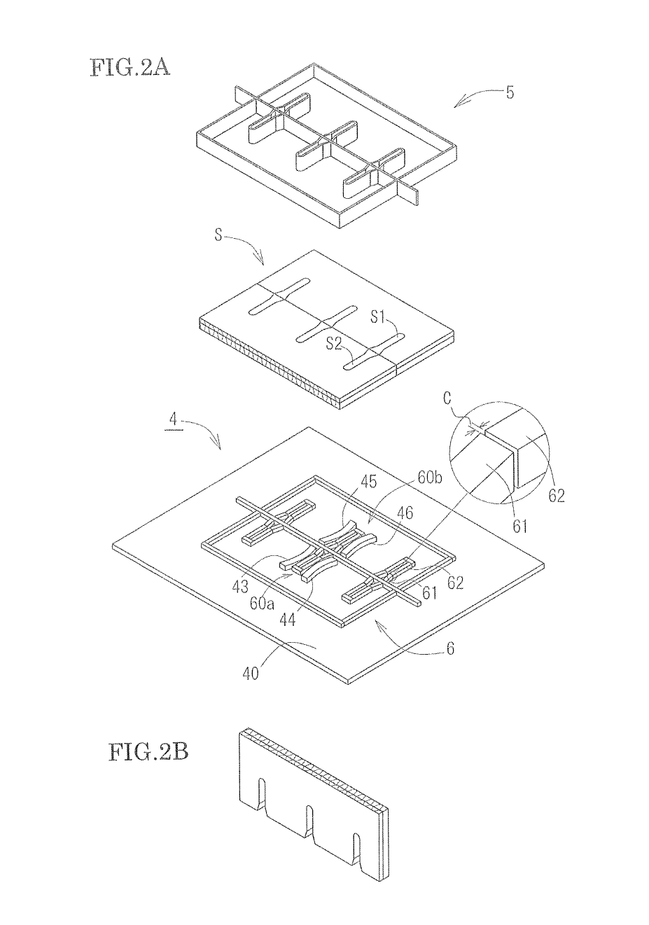

The auxiliary plate 4 is described further in detail. FIG. 2A shows a cutting example of the sheet member S. FIG. 2A illustrates a set of cutting blades (a cutting-blade group) 5 combined for cutting the sheet member S, and also illustrates a set of cutting-blade contact portions (a cutting-blade contact-portion group) 6 that receive contact of the cutting-blade group 5. By cutting the sheet member S as illustrated in FIG. 2A, a corrugated-cardboard partition board is manufactured as shown in FIG. 2B.

As shown in FIG. 2A, in order to cut the sheet member S in a predetermined shape, individual cutting blades that constitute the cutting-blade group 5 are partially curved or bent, or partially cut or connected, so as to conform to the predetermined shape. This shape is then held by a die board as described previously.

Meanwhile, the cutting-blade contact-portion group 6 is provided on the surface of the plate body 40 with an appropriate area, while bar-shaped members, each of which has a rectangular shape in cross section, and is cut in an appropriate length, are connected to each other. At this time, in comparison to the cutting-blade group 5, the shape of the cutting-blade contact-portion group 6 does not conform to the accurate cutting position. However, the cutting-blade contact-portion group 6 is at a position where the distal end (the blade edge) of the cutting-blade group 5 can come into contact with approximately the center of the surface (the contact surface). Individual members that constitute the cutting-blade contact-portion group 6 are welded to the plate body 40 in the present embodiment. Even when the cutting-blade group 5 is brought into contact with the cutting-blade contact-portion group 6 with a high pressure, the individual members are not easily detached from the plate body 40. The cutting-blade contact-portion group 6 is required to have a strength enough to receive contact of the cutting-blade group 5. Therefore, in the present embodiment, stainless steel (SUS) is used for the cutting-blade contact-portion group 6.

In the cutting example illustrated in FIG. 2A, the sheet member S is provided partially with cut-out regions S1 and S2 that are cut along the entire periphery. These cut-out regions S1 and S2 are a portion cut out from the product (see FIG. 2B), and removed from the product as an unnecessary section. However, in the case where the cut-out regions S1 and S2 are completely cut out at the time of cutting processing, these cut-out regions S1 and S2 easily come off the other portion. Therefore, in the present embodiment, cutting-blade contact portions 61 and 62 for cutting the cut-out regions S1 and S2 are discontinued. That is, in principle, the contact surface of the cutting-blade contact-portion group 6 is arranged to be continuous so as to receive contact of the entire blade edge of the cutting-blade group 5. However, with exception, a portion of the contact surface of the cutting-blade contact-portion group 6 is discontinued, and in the discontinued portion, a slight clearance C is formed between the edges of two adjacent cutting-blade contact portions 61 and 62.

The cutting-blade contact portions 61 and 62 are arranged in a discontinued manner as described above, and therefore even in the case where the cutting-blade group 5 in its entirety (the entire blade edge) is provided continuously, the sheet member S can be processed so as not to be completely cut on the back side. A state, where the sheet member S is not completely cut, means that although the sheet member S is cut to some extent by the entry of the cutting-blade group 5 into the sheet member S, an uncut portion still remains at the distal end of the sheet member S (on the back side of the sheet member S). As described previously, this is because the sheet member S is pressed by the cutting-blade group 5 with a high pressure, and this pressing force comes into contact with the cutting-blade contact-portion group 6 to cut the sheet member S, however, there is the clearance C between the cutting-blade contact portions 61 and 62, and there is accordingly a portion of the cutting-blade contact-portion group 6, to which the pressing force cannot be applied. The pressing force is not sufficiently applied to the sheet member S, and therefore the sheet member S can be brought into a state of being cut mostly through its thickness (almost the entire thickness), while remaining slightly uncut.

As described above, the cut-out regions S1 and S2 do not completely come off the sheet member S, and therefore even after the cutting processing, the sheet member S can still be removed integrally from the processing device. It is impossible for a conventional processing device to perform this kind of processing. As in the present invention, mounting the auxiliary plate 4 only makes it possible to perform this kind of processing.

As shown in FIG. 2A, the elastic members 43, 44, 45, and 46 are provided near a portion of the cutting-blade contact-portion group 6, which is denoted by the numerals 60a and 60b. These elastic members 43 to 46 are not provided to all cutting-blade contact portions, but are provided when there is a relatively long distance from a neighboring cutting-blade contact portion. The elastic members 43 to 46 are provided as a shock-absorbing member when the sheet member S deforms downward (toward the plate body 40) at the time of cutting processing.

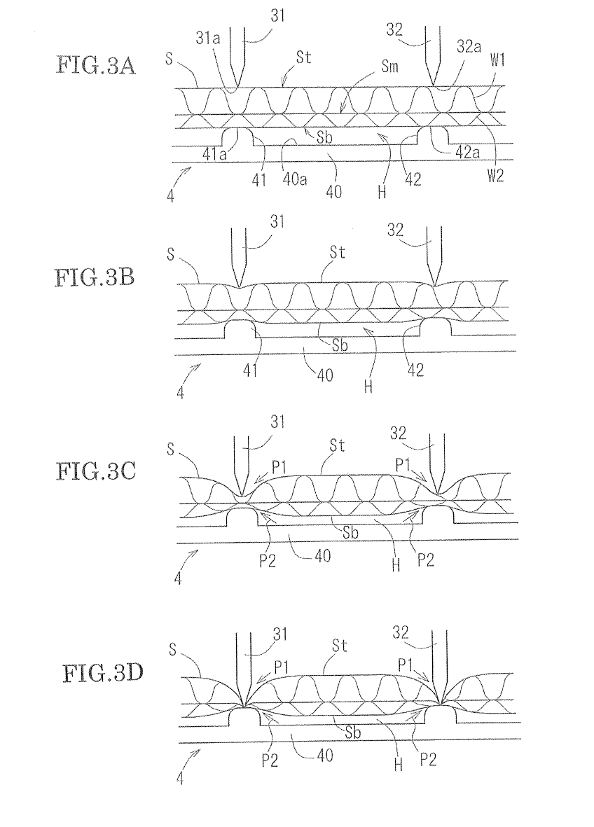

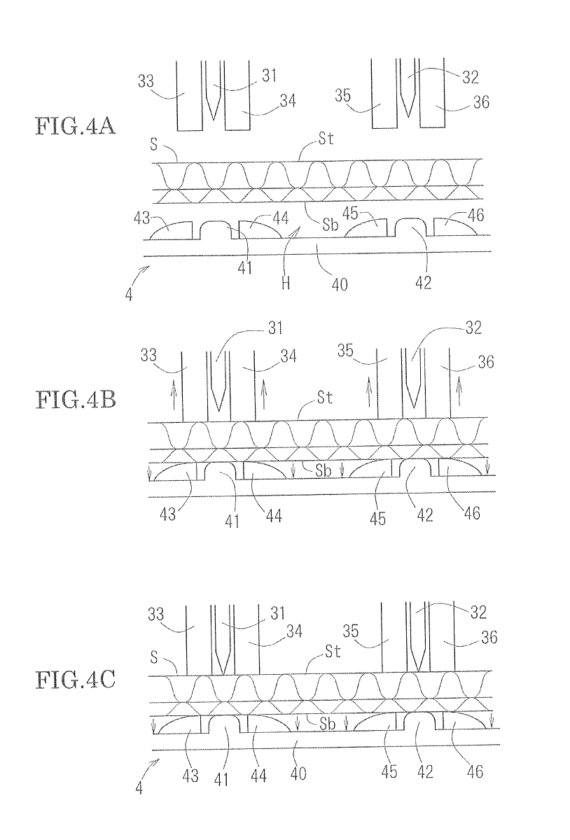

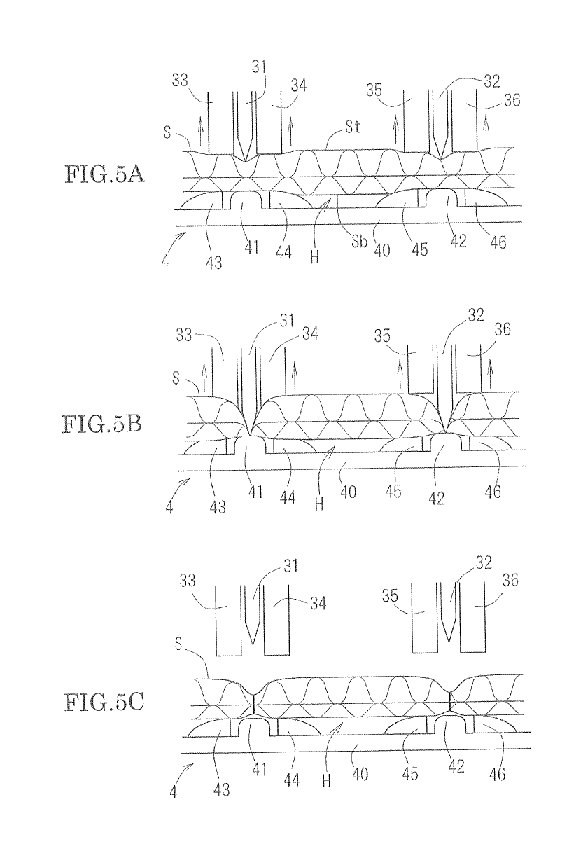

Next, a state where the sheet member S is cut according to the present embodiment is described. Since the first embodiment of the present invention is configured as described above, the sheet member S is cut at the height of a contact surface of a cutting-blade contact portion. This state is shown in FIG. 3 to FIG. 5. FIG. 3 show the case where no elastic member is provided near the cutting-blade contact portion. FIG. 4 and FIG. 5 show the case of including an elastic member.

In the case where no elastic member is provided near the cutting-blade contact portion, as shown in FIG. 3A, the sheet member S is located in a state where the back surface Sb is brought into contact with the contact surfaces 41a and 42a that are formed on the top of the cutting-blade contact portions 41 and 42. At this time, a portion of the back surface Sb of the sheet member S, which is positioned in a region H where the cutting-blade contact portions 41 and 42 are not located, is in a state of forming a clearance corresponding to the protruding length of the cutting-blade contact portions 41 and 42 from a plate-body surface 40a of the auxiliary plate 4. Therefore, a space region H is formed in this region H. In this state, the cutting blades 31 and 32 are brought closer to the sheet member S, and therefore the distal ends (the blade edges) 31a and 32a of the cutting blades 31 and 32 apply a pressing force to a surface St of the sheet member S. As an example of the sheet member S, a double-wall corrugated cardboard is illustrated as shown in FIG. 3. The double-wall corrugated cardboard is a corrugated cardboard in which a medium sheet Sm is arranged in the middle between the surface (a surface sheet) St and the back surface (a back sheet) Sb of the sheet member S, a first corrugated web W1 is stacked between the surface sheet St and the medium sheet Sm, and a second corrugated web W2 is stacked between the medium sheet Sm and the back sheet Sb. The webs W1 and W2 illustrated in FIG. 3 are formed such that the first web W1 is larger, and the second web W2 is smaller. However, there is a case of cutting other types of corrugated cardboard such as a corrugated cardboard with equal size of the first and second webs W1 and W1, a single-wall corrugated cardboard, or a triple or more multi-wall corrugated cardboard.

As shown in FIG. 3B, the cutting blades 31 and 32 are brought even closer to the auxiliary plate 4 than in the above state, and therefore start cutting the sheet member S. At the start of cutting, initially, the cutting blades 31 and 32 solely apply a pressing force to the cut position of the sheet member S, and compress the cut position of the sheet member S. As known in public, this is because unless the blade edges 31a and 32a of the cutting blades 31 and 32 apply a sufficient compressive force (a cutting pressure) between the blade edges 31a and 32a and receivers (the cutting-blade contact portions) 41 and 42, the sheet member S cannot reach a cutting limit.

At this time, as shown in FIG. 3C, the sheet member S receives a pressing force from the cutting blades 31 and 32, and deforms. The sheet member S deforms into a curved shape, such that the sheet member S is thinnest at the contact position with the cutting blades 31 and 32, and such that a portion of the sheet member S, which is distant from the cutting blades 31 and 32, is thickest (with the original thickness). In other words, the thicker portion at this time is in a bulging state on the surface side and on the back side relative to the thinner portion. The sheet member S is capable of freely bulging on a top surface St-side in the middle between the cutting blades 31 and 32, and can freely bulge also on a bottom surface Sb-side within the range where the space region H is formed. That is, the above space region H functions as a clearance region for a bulging portion.

Therefore, as shown in FIG. 3C, in the case where the cutting blades 31 and 32 are brought further closer to the auxiliary plate 4 to apply a pressing force to a degree close to the cutting limit for the sheet member S, the deforming state of the sheet member S reaches the absolute limit, and thus the sheet member is in a more bulging state. At the time of the change in the sheet member S as described above, the surface St of the sheet member S is pulled by the cutting blades 31 and 32. Accordingly, a tensile stress P1 in a horizontal direction (in a direction along the surface St or the back surface Sb of the sheet member S) is applied, which is maximized near the cutting blades 31 and 32. Because in the present embodiment, the space region H is formed between the sheet member S and the plate body 40, it is possible for the sheet member S to bulge also on the back surface Sb-side. With this configuration, a tensile stress P2 in the horizontal direction is applied also to the back surface Sb of the sheet member S. Because these tensile stresses P1 and P2 are distributed to both the surface St and the back surface Sb of the sheet member S, a high load is prevented from concentrating only on one of the surface St and the back surface Sb. Preventing concentration of the load can demonstrate the effect of preventing the occurrence of a crack or a break on the surface of the sheet member S.

When the cutting blades 31 and 32 further press the sheet member S, and then exceed the cutting limit of the sheet member S, the sheet member S is cut as shown in FIG. 3D. At this time, the sheet member S is released from the pressing force of the cutting blades 31 and 32 as described previously. However, the surface St and the back surface Sb remain deformed near their edges due to the pressing force at the time of cutting the sheet member S. At this time, the sheet member S at least works to restore its thickness, and the cutting blades 31 and 32 are in a state of entering into the cut region of the sheet member S. Therefore, a portion of the cutting blades 31 and 32, which corresponds to the thickness, presses the edges of the cut portions of the sheet member S, and thus compresses the sheet member S in the horizontal direction. This compressive force is applied to the sheet member S in its entirety. In this case also, the compressive force is eliminated by bulging the surface St and the back surface Sb of the sheet member S.

According to the aspect of the processing as described above, it is possible for the sheet member S that is to be processed (a workpiece member) to deform (bulge) on the back surface Sb-side. Therefore, a tensile load and a compressing load on the sheet member S at the time of cutting processing can be distributed, and the likelihood of the occurrence of a break, a crack, or other damage can be minimized.

Next, a state at the time of cutting in the case of including an elastic member is described. First, as shown in FIG. 4A, before cutting, the sheet member S that is a workpiece member is located on the auxiliary plate 4. As shown in FIG. 4A, in the case where the top end of the elastic members 43, 44, 45, and 46 is positioned at a height equal to that of the contact surfaces 41a and 42a of the cutting-blade contact portions 41 and 42, the sheet member S is supported by the contact surfaces 41a and 42a. In contrast to this, in the case where the top end of the elastic members 43 to 46 is positioned higher than the contact surfaces 41a and 42a, the sheet member S is supported by the elastic members 43 to 46.

From this state, by bringing the cutting blades 31 and 32 closer to the auxiliary plate 4, the elastic members 33, 34, 35, and 36 located near the cutting blades 31 and 32 come into contact with the surface St of the sheet member S (FIG. 4B). The elastic members 33 to 36 beside the cutting blades 31 and 32 elastically deform, and therefore the cutting blades 31 and 32 become closer to the auxiliary plate 4 (reach the surface St of the sheet member S) (FIG. 4C). At this time, the elastic members 33 to 36 deform so as to shrink in a direction opposite to its protruding direction, and their protruding length is gradually decreased. In the case where the top end of the elastic members 43 to 46, provided near the cutting-blade contact portions 41 and 42, is positioned higher than the contact surfaces 41a and 42a, the elastic members 43 to 46 start deforming simultaneously with the above elastic deformation of the elastic members 33 to 36 on the cutting-blade side. As the protruding length of the elastic members 43 to 46 beside the cutting-blade contact portions 41 and 42 is decreased, the back surface Sb of the sheet member S becomes gradually closer to the contact surfaces 41a and 42a of the cutting-blade contact portions 41 and 42.

Further, by bringing the cutting blades 31 and 32 closer to the auxiliary plate 4, the distal ends (the blade edges) 31a and 32a of the cutting blades 31 and 32 come into contact with the surface St of the sheet member S. From this state, a pressing force of the cutting blades 31 and 32 can be applied to the sheet member S.

Therefore, as shown in FIG. 5A, by applying a pressing force of the cutting blades 31 and 32 to the sheet member S, the sheet member S initially starts deforming. In this case also, because the space region H is formed on the back surface Sb-side, a bulge caused by the above deformation appears on both the surface St and the back surface Sb of the sheet member S, and therefore a tensile stress applied to the sheet member S is distributed to both the surface St and the back surface Sb.

As shown in FIG. 5B, immediately after cutting the sheet member S, both the surfaces St and Sb of the sheet member S remain deformed near the cut position, and there are a upwardly-bulging portion on the surface St, and a bulging portion on the back surface Sb in the space region H. The edges of the cut portions of the sheet member S slightly work so as to restore. By the entry of the cutting blades 31 and 32, a compressive force in the horizontal direction is slightly applied to the sheet member S. However, in this case also, the compressive force can be managed by deformation caused by a bulge of the surface St and the back surface Sb of the sheet member S.

After cutting the sheet member S, in the case of moving the cutting blades 31 and 32 in a direction away from the auxiliary plate 4, as shown in FIG. 5C, the elastic members 33 to 36 provided beside the cutting blades 31 and 32, and the elastic members 43 to 46 provided beside the cutting-blade contact portions 41 and 42 apply an elastic force to release the sheet member S from contact with the cutting blades 31 and 32 and with the cutting-blade contact portions 41 and 42. Particularly, the elastic members 33 to 36 beside the cutting blades 31 and 32 generate a repulsion force in a direction to remove the cutting blades 31 and 32, having entered into the sheet member S, from this sheet member S. Therefore, the elastic members 33 to 36 have a function of preventing the sheet member S from moving in a contact state with the cutting blades 31 and 32.

In the present embodiment, an elastic force of elastic members located beside the cutting blades 31 and 32 can be reduced. That is, as described previously, at the time of cutting the sheet member S (see FIG. 5B), a compressive stress in a horizontal direction to the sheet member S is applied, and then this compressive stress is applied to the side of the cutting blades 31 and 32. This results in a friction resistance between the edges of the cut portions and the cutting blades 31 and 32. Particularly, the elastic members 33 to 36 are operated in the vertical direction in order to eliminate the press-fit state caused by the friction resistance. In the present embodiment, because the compressive stress in the horizontal direction is distributed toward the back surface Sb of the sheet member S, a compressive force applied to the side of the cutting blades 31 and 32 can be reduced, and thus a friction resistance can be decreased.

By locating the elastic members 43 to 46 beside the cutting-blade contact portions 41 and 42, a portion of the back surface Sb of the sheet member S, which bulges in the space region H, can be prevented from remaining in a bulging state in the space region H. Further, when the back surface Sb of the sheet member S bulges (at the time of deformation), this back surface Sb can be prevented from partially contacting a portion of the cutting-blade contact portions 41 and 42, and thus prevented from causing a break. An elastic force of these elastic members 33 to 36 and 43 to 46 can be made relatively small. Therefore, the elastic members 33 to 36 and 43 to 46 do not apply a considerable repulsion force to the sheet member S. When the sheet member S deforms, a reduced friction resistance due to a repulsion force, or deformation of the elastic members 33 to 36 and 43 to 46 themselves, allows deformation of the sheet member S. With this configuration, the sheet member S can deform adequately and freely. Consequently, a cause of a break or other damage at the time of cutting the sheet member S can be further avoided.

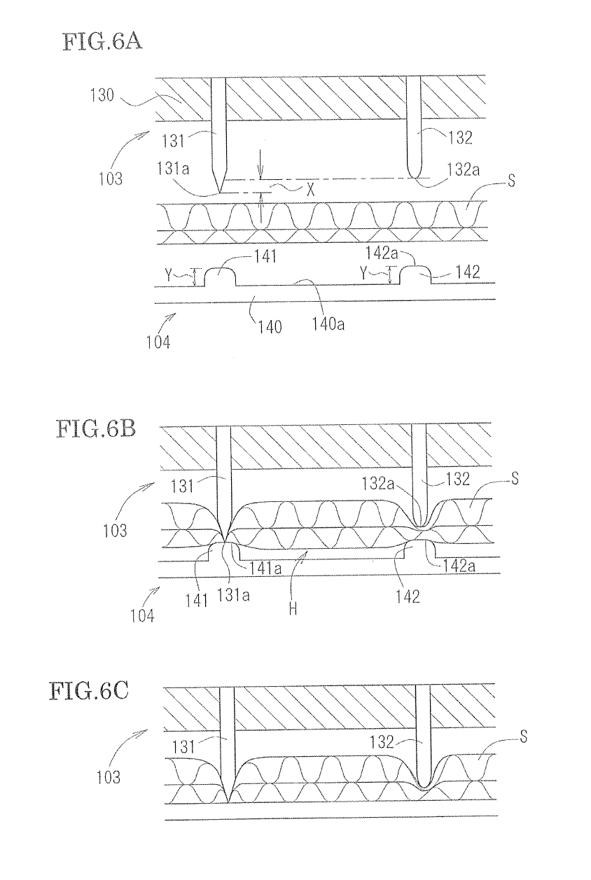

Next, a second embodiment of the present invention is described with reference to FIG. 6. As shown in FIG. 6A, in the present embodiment, in a base portion 130 of a stamping die 103, a ruled-line pressing blade 132 is provided in addition to a cutting blade 131. The ruled-line pressing blade 132 is not designed to cut the sheet member S, but is designed to form a ruled line (a thinner portion to be bent) on the surface side of the sheet member S. Therefore, a distal end 132a has an appropriate shape according to the shape of a ruled line to be formed. In the present embodiment, the distal end 132a with a semicircular shape in cross section is illustrated in FIG. 6A. The ruled-line pressing blade 132 is located so as to have a protruding length less than the protruding length of the cutting blade 131 by an appropriate length X.

In the present embodiment, a convex portion 142 is formed at a position to receive a pressing force of the above ruled-line pressing blade 132. Basically, this convex portion 142 is configured identically to a cutting-blade contact portion 141 for the cutting blade 131. The convex portion 142 is provided to protrude from a surface 140a of a plate body 140 that constitutes an auxiliary plate 104. At the distal end of the convex portion 142, a flat portion 142a is formed with an appropriate area. In the present embodiment, a protruding length Y of the convex portion 142 is equal to a protruding length Y of the cutting-blade contact portion 141.

As described above, the height of the flat portion 142a of the convex portion 142 is equal to the height of the contact surface 141a of the cutting-blade contact portion 141. Therefore, as shown in FIG. 6B, in a state where a blade edge 131a of the cutting blade 131 comes into contact with the contact surface 141a of the cutting-blade contact portion 141, the distal end 132a of the ruled-line pressing blade 132 cannot reach the flat portion 142a of the convex portion 142. That is, it is possible to perform cutting processing by bringing the stamping die 103 and the auxiliary plate 104 closer to each other to bring the blade edge 131a of the cutting blade 131 into contact with the contact surface 141a of the cutting-blade contact portion 141. At this time, the stamping die 103 and the auxiliary plate 104 are in the closest state in their relative positional relationship. In the state where the stamping die 103 and the auxiliary plate 104 are closest to each other, a clearance is formed between the flat portion 142a of the convex portion 142 and the distal end 132a of the ruled-line pressing blade 132 by a distance corresponding to the appropriate length X. This clearance is made less than the thickness of the sheet member S. Therefore, simultaneously with the cutting processing, the sheet S can be partially pressed, and a pressed portion of the sheet member S can be thinned, while the sheet member S is not cut by the ruled-line pressing blade 132.

Also in the processing as described above, because the space region H is formed on the auxiliary plate 104, this space region H can function as a clearance region when the sheet member S deforms (bulges) at the time of cutting processing. In the present embodiment, the sheet member S is cut by the cutting blade 131 at a height that corresponds with the height at which a ruled line is formed by the ruled-line pressing blade 132. Therefore, assuming that a flat cutting plate is used, a stamping die, having been used previously, can still be used.

As described above, the sheet member S is compressed between the ruled-line pressing blade 132 and the convex portion 142, and therefore both surfaces of the sheet member S are pulled between the cutting blade 131 and the ruled-line pressing blade 132. Even in this case, by forming the space region H on the back side, the deformation can be absorbed. This is different from the case of using the ruled-line pressing blade 132 on a conventional flat plate. That is, as shown in FIG. 6C, in the case of pressing the ruled-line pressing blade 132 against a conventional flat plate, the sheet member S on the back side cannot deform, and eventually deforms only on the surface side. Therefore, the sheet member S on the surface side is pulled considerably, which causes a partial break (a so-called “crack”) sometimes. In contrast to this, in the present embodiment, as shown in FIG. 6B, it is possible for the sheet member S to also deform on the back side, and therefore the sheet member S deforms both on the surface side and the back side in a distributed manner. This can reduce the occurrence of a partial break on the surface side.

While illustrations of an elastic member are omitted in FIG. 6, an elastic member may be provided near the cutting blade 131 or the cutting-blade contact portion 141. Further, an elastic member may also be provided near the ruled-line pressing blade 132 and the convex portion 142. Taking into account the material, thickness, and other factors of the sheet member S to be processed, an elastic member can selectively be arranged accordingly.

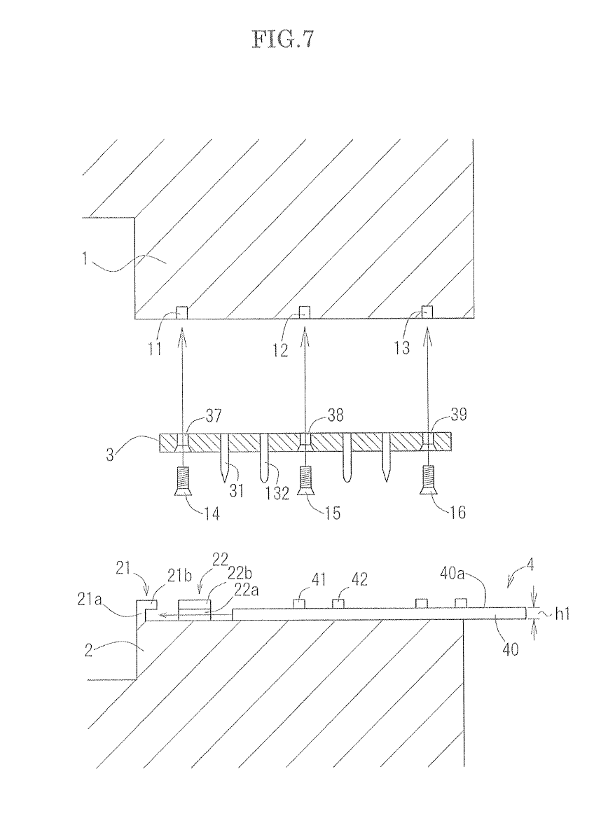

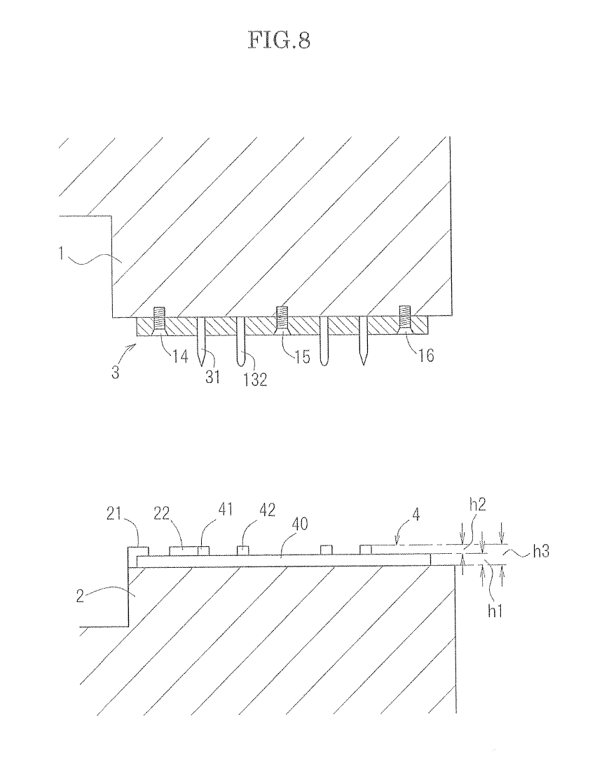

Next, a processing device using the auxiliary plate 4 or 104 described above is explained with reference to FIGS. 7 and 8. FIG. 7 shows a processing device using the auxiliary plate 4 according to the first embodiment in a state before locating the stamping die 3 and the auxiliary plate 4. FIG. 8 is a cross-sectional view of the processing device after the stamping die 3 and the auxiliary plate 4 have been located.

As shown in FIG. 7, in the punching die portion 1, female screw portions 11, 12, and 13 for locating the stamping die 3 are provided. These female screw portions 11 to 13 receive fixing screws 14, 15, and 16. These fixing screws 14 to 16 pass through the stamping die 3 so as to fix the stamping die 3. The female screw portions 11 to 13 are used for all stamping dies 3 to be located, regardless of the type and other factors of the stamping dies 3. In the stamping die 3, through holes 37, 38, and 39 are provided at a position where the fixing screws 14 to 16, to be screwed into the above female screw portions 11 to 13, can pass through. With this configuration, the stamping die 3 is located at a predetermined position on the punching die portion 1 based on the above female screw portions 11 to 13. Therefore, a positioning portion is configured by the above female screw portions 11 to 13, and the above fixing screws 14 to 16.

Meanwhile, in the cutting plate portion 2, hook stoppers 21 and 22 having an inverted L-shape in cross section are provided to protrude from the surface at least at two points. The hook stoppers 21 and 22 are configured by support portions 21a and 22a, and holding portions 21b and 22b that hold the surface 40a of the plate body 40 of the auxiliary plate 4 from the top end of the support portions 21a and 22a, respectively. A clearance that is as great as a thickness h1 of the plate body 40 of the auxiliary plate 4 is provided between the surface of the cutting plate portion 2 and the holding portions 21b and 22b. One hook stopper 21 regulates the position of the auxiliary plate 4 in its depth direction. The other hook stopper 22 regulates the position of the auxiliary plate 4 in its width direction. The hook stoppers 21 and 22 function as a positioning portion of the plate body 40 by regulating the auxiliary plate 4 in two directions that are the depth and width directions. When a portion of the edge of the plate body 40 is brought into contact with the support portions 21a and 22a, the holding portions 21b and 22b prevent the plate body 40 from being displaced upward. This is intended to preliminarily prevent the auxiliary plate 4, to which a considerable pressing force is applied at the time of cutting processing, from being moved by this pressing force. Therefore, in the case where there is no likelihood of such a movement, the holding portions 21b and 22b may not be provided.

In the case of using the processing device according to the present embodiment, the stamping die 3, and also the auxiliary plate 4 that pairs up with this stamping die 3 are manufactured in advance. At this time, the auxiliary plate 4 is manufactured such that when the auxiliary plate 4 is mounted on the cutting plate portion 2, while being regulated by the hook stoppers 21 and 22 thereof, the position of the cutting-blade contact portion 41, and the position of the convex portion 142 are opposed respectively to the position of the cutting blade 31, and the position of the ruled-line pressing blade 132 when the stamping die 3 is located on the punching die portion 1.

According to the processing device as described above, as shown in FIG. 8, the stamping die 3 and the auxiliary plate 4 that are manufactured in advance as a pair are used, and the stamping die 3 is located at a predetermined position by the fixing screws 14 to 16. When the auxiliary plate 4 is mounted in a state of being regulated by the hook stoppers 21 and 22, the cutting blade 31 and the ruled-line pressing blade 132 can be reliably located opposed respectively to the cutting-blade contact portion 41, and the convex portion 142. Even in the case of using a stamping die 3 having been already manufactured, the auxiliary plate 4 that pairs up with this stamping die 3 is manufactured. Therefore, the cutting-blade contact portion 41 and the convex portion 142, which are located on the auxiliary plate 4, can be arranged to be opposed respectively to the cutting blade 31 and the ruled-line pressing blade 132.

In the case of mounting the auxiliary plate 4 on the cutting plate portion 2 as described above, the top surface (the contact surface) of the cutting-blade contact portion 41 is positioned above the surface of the cutting plate portion 2, and the position, on which the distal end (the blade edge) of the cutting blade 31 comes into contact with this top surface, is set as an approach limit between the punching die portion 1 and the cutting plate portion 2. That is, in comparison to the case of processing by means of bringing the distal end (the blade edge) of the cutting blade 31 into contact with the surface of the cutting plate portion 2, the length of a back-and-forth stroke of the cutting plate portion 2 is reduced. The stroke length is changed by a distance corresponding to a sum h3 of the thickness h1 of the plate body 40 and a protruding length h2 of the cutting-blade contact portion 41. Assuming that the thickness h1 of the plate body 40 and the protruding length h2 of the cutting-blade contact portion 41 are kept constant, it is unnecessary to adjust the stroke length as long as the auxiliary plate 4 is used because the conditions of the stoke length remain the same.

The approach limit between the punching die portion 1 and the cutting plate portion 2 is a limiting point when either one of the punching die portion 1 and the cutting plate portion 2 is moved in order to bring the cutting blade 31 into contact with the cutting-blade contact portion 41 at the time of cutting processing. This means that either one of the punching die portion 1 and the cutting plate portion 2 can be moved further than the approach point. That is, with respect to the above limiting point, it is necessary to further apply a pressing force required for cutting. Therefore, in order to apply the pressing force, an operation is required for further moving either one of them in the approaching direction. Accordingly, even when the pressing force is applied, the position of the punching die portion 1 or the cutting plate portion 2 does not change, and thus the expression “approach limit” is adopted.

The embodiments of the present invention are as described above. When the auxiliary plate 4 according to the above embodiment is used, the space region H is formed in a range where the cutting-blade contact portions 41 and 42 are not provided. This makes it possible for the sheet member S to deform (bulge) on the back side at the time of cutting processing, reduces a tensile load to be applied to the surface of the sheet member S, and accordingly can reduce damage such as a break on the surface. As described above, because the sheet member S is allowed to bulge (deform) on both surfaces, the fitted amount of the sheet member S, having been cut by a cutting blade, into the stamping die 3-side can be reduced. This can decrease the application of an elastic force (a repulsion force) of the elastic members 33 to 36 provided in the stamping die 3.

According to the sheet-member processing device in the above embodiment, the stamping die 3 can be located at a predetermined position on the punching die portion 1, and the auxiliary plate 4 can be located at a predetermined position on the cutting plate portion 2. Therefore, a relative positional relationship between the stamping die 3 and the auxiliary plate 4 can be maintained in the same state during use of the sheet-member processing device. With this configuration, the cutting blade 31 of the stamping die 3, and the cutting-blade contact portion 41 of the auxiliary plate 4 are manufactured based on the above located state, and therefore cutting processing can be performed with the cutting blade 31 and the cutting-blade contact portion 41 as a pair.

While the embodiments of the present invention have been described as above, the present invention is not intended to be limited to the above embodiments. That is, various changes may be made as necessary. For example, in the processing device according to the above embodiment, the fixing screws 14 to 16 are illustrated as a method for positioning the stamping die 3. However, the present invention is not limited thereto, and may employ a method for positioning the periphery of the stamping die 3. In this case, a configuration is assumed in which a hook stopper is provided also in the punching die portion 1, the die board 30 forming the stamping die 3 is fixed to an attachment base, and this base is supported by the hook stopper in the punching die portion 1. The hook stoppers 21 and 22 are illustrated as a method for positioning the auxiliary plate 4. However, the present invention is not limited thereto. Stoppers that surround the periphery of the auxiliary plate 4 may also be used. Further, in the embodiment of the processing device, the example in which no elastic member is located near the cutting blade 31 of the stamping die 3 is the illustrated. However, the processing device in which an elastic member is located may also be employed.

### DESCRIPTION OF THE REFERENCE NUMERALS

1/ PUNCHING DIE PORTION
2/ CUTTING PLATE PORTION
3, 103/ STAMPING DIE
4, 104/ AUXILIARY PLATE
5/ CUTTING-BLADE GROUP
6/ CUTTING-BLADE CONTACT-PORTION GROUP
11, 12, 13/ FEMALE SCREW PORTION
14, 15, 16/ FIXING SCREW
21, 22/ HOOK STOPPER
21a, 22a/ SUPPORT PORTION OF HOOK STOPPER
21b, 22b/ HOLDING PORTION OF HOOK STOPPER
30, 130/ BASE PORTION OF STAMPING DIE
31, 32, 131/ CUTTING BLADE
31a, 32a, 131a/ DISTAL END OF CUTTING BLADE (BLADE EDGE)
33, 34, 35, 36/ ELASTIC MEMBER
40, 140/ PLATE BODY
40a, 140a/ SURFACE OF PLATE BODY
41, 42, 141/ CUTTING-BLADE CONTACT PORTION
41a, 42a, 141a/ CONTACT SURFACE OF CUTTING-BLADE CONTACT PORTION
43, 44, 45, 46/ ELASTIC MEMBER
132/ RULED-LINE PRESSING BLADE
132a/ DISTAL END OF RULED-LINE PRESSING BLADE
142/ CONVEX PORTION
142a/ DISTAL END OF CONVEX PORTION
S/ SHEET MEMBER
S1, S2/ CUT-OUT REGION
St/ SURFACE OF SHEET MEMBER (SURFACE SHEET)
Sb/ BACK SURFACE OF SHEET MEMBER (BACK SHEET)
Sm/ MEDIUM SHEET
W1, W2/ WEB
H/ SPACE REGION

What is claimed is:

1. An auxiliary plate for a sheet-member processing device that includes a punching die portion that holds a stamping die with a cutting blade arranged in a predetermined shape, and a cutting plate portion that is arranged opposed to this punching die portion to place thereon a sheet member that is a workpiece material, the sheet-member processing device bringing the punching die portion and the cutting plate portion closer to each other to cut a sheet member, in which the auxiliary plate is mounted on a surface of the cutting plate portion, the auxiliary plate comprising:
a plate body with a flat-plate shape; a cutting-blade contact portion that is provided on a surface of this plate body at a position opposed to a cutting blade arranged in the stamping die, so as to protrude from the surface, while including a contact surface with a width dimension greater than a thickness of the cutting blade; and an elastic member that is arranged near a portion of the cutting-blade contact portion along the cutting-blade contact portion, and that is provided to protrude from the surface of the plate body, wherein the contact surface of the cutting-blade contact portion is chamfered at both edges in its width direction.

2. The auxiliary plate for a sheet-member processing device according to claim 1, wherein the elastic member has a protruding length greater than that of the cutting-blade contact portion.

3. The auxiliary plate for a sheet-member processing device according to claim 1, wherein the cutting-blade contact portion is configured to be split into a plurality of sections, and a contact surface of the cutting-blade contact portion is partially discontinued.

4. The auxiliary plate for a sheet-member processing device according to claim 1, wherein the cutting-blade contact portion has a protruding length less than a thickness of the workpiece material.

5. The auxiliary plate for a sheet-member processing device according to claim 1, wherein the plate body includes a convex portion that protrudes from the surface of the plate body at a position opposed to a ruled-line pressing blade located in the stamping die.

6. The auxiliary plate for a sheet-member processing device according to claim 5, wherein the convex portion of the plate body protrudes to a height equal to that of a surface of the cutting-blade contact portion.

7. The auxiliary plate for a sheet-member processing device according to claim 5, wherein the convex portion of the plate body is provided with its distal end protruding more than the cutting-blade contact portion.

8. An auxiliary plate for a sheet-member processing device that includes a punching die portion that holds a stamping die with a cutting blade arranged in a predetermined shape, and a cutting plate portion that is arranged opposed to this punching die portion to place thereon a sheet member that is a workpiece material, the sheet-member processing device bringing the punching die portion and the cutting plate portion closer to each other to cut a sheet member, in which the auxiliary plate is mounted on a surface of the cutting plate portion, the auxiliary plate comprising:
a plate body with a flat-plate shape; and a cutting-blade contact portion that is provided on a surface of this plate body at a position opposed to a cutting blade arranged in the stamping die, so as to protrude from the surface, while including a contact surface with a width dimension greater than a thickness of the cutting blade, wherein the cutting-blade contact portion is configured to be split into a plurality of sections, a contact surface of the cutting-blade contact portion is partially discontinued, and the contact surface of the cutting-blade contact portion is chamfered at both edges in its width direction.

9. The auxiliary plate for a sheet-member processing device according to claim 8, wherein the cutting-blade contact portion has a protruding length less than a thickness of the workpiece material.

10. The auxiliary plate for a sheet-member processing device according to claim 8, wherein the plate body includes a convex portion that protrudes from the surface of the plate body at a position opposed to a ruled-line pressing blade located in the stamping die.

11. The auxiliary plate for a sheet-member processing device according to claim 10, wherein the convex portion of the plate body protrudes to a height equal to that of a surface of the cutting-blade contact portion.

12. The auxiliary plate for a sheet-member processing device according to claim 10, wherein the convex portion of the plate body is provided with its distal end protruding more than the cutting-blade contact portion.
